(19) United States
(12) Patent Application Publication
(10) Pub. No.: US 2008/0165208 A1
(43) Pub. Date: Jul. 10, 2008

(54) 3-Dimensional graphic processing apparatus and operating method thereof

(75) Inventors: Jae-Wan Bae, Suwon-si (KR); Yun-Seok Choi, Suwon-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/003,998

(22) Filed: Jan. 4, 2008

(30) Foreign Application Priority Data
Jan. 5, 2007 (KR) 10-2007-01518

(51) Int. Cl. G09G 5/00

(52) U.S. Cl. 345/620

(57) ABSTRACT

A graphic processing method may include clipping a first polygon with a near plane of a view volume to create a second polygon, clipping the second polygon with a far plane of the view volume to create a third polygon, and/or discriminating if a homogeneous coordinate of the third polygon is 0. The third polygon may be clipped to one of left, right, top, and bottom planes of the view volume if the homogeneous coordinate of the third polygon is 0.

### PRIORITY STATEMENT

This U.S. non-provisional patent application claims the benefit of priority under 35 U.S.C. § 119 to Korean Patent Application No. 10-2007-0001518, filed on Jan. 5, 2007, the entire contents of which are incorporated herein in their entirety by reference.

### BACKGROUND

1. Field

Example embodiments relate to graphic processing apparatuses and/or methods thereof, and for example, to a 3-dimensional graphic processing apparatus and/or a method thereof.

2. Description of Related Art

Computing systems are generally used for displaying graphic objects on screens. 3-dimensional graphic systems are useful to generate 3-dimensional images realistically displaying an object or objects in 3 dimensions on computational screens. In the physical world, objects are presented by occupying 3-dimensional spaces with heights, widths, and depths. Photographs are 2-dimensional representations of 3-dimensional spaces. 3-dimensional graphic systems are substantially similar to photographs in that 3-dimensional visions are represented in 3-dimensional spaces of computational screens, except that lower images are modeled into 3-dimensional geometric and surface textures.

Images created by 3-dimensional graphic systems are widely used in various applications, e.g., video games, animations, aviation simulators, and so on, depicting individual views of scenes at given time points. Recently, 3-dimensional graphic images are even depicted on mobile graphic apparatuses, e.g., portable multimedia players (PMPs), mobile phones, personal digital assistants (PDAs), and so forth.

The field of computer games is an industry which is rapidly growing, and which requires faster 3-dimensional graphic display.

3-dimensional graphic systems process and transform 3-dimensional scenes of objects into data signals that may be loaded on display units. A scene of a 3-dimensional object may be represented by a plurality of polygons (or primitives) approximating a pattern of the object. A process for representing a 3-dimensional image on a 2-dimensional display unit uses a relatively complicated arithmetic procedure. The process is carried out relatively slowly even by current microprocessors and graphic processing units.

Rasterization is a process for transforming a simple geometric presentation of a graphic polygon into pixels for display. A polygon may be depicted in dot, line, or triangle. An object is generally transformed into one or more polygons before rasterization. A triangle as polygon is depicted by means of a coordinate (x, y, z), and other properties at vertices, e.g., colors and texture coordinates. A vertex coordinate (x, y) of a polygon represents a position on a display unit. A coordinate value (z) represents a distance of a vertex from a selected view point of a 3-dimensional scene.

One method for improving a 3-dimensional graphic processing speed is to conduct clipping steps with near and far planes only, instead of conducting clipping steps with all planes, i.e., top, bottom, left, right, near, and far planes, in a view volume clipping operation. For the top, bottom, left, and right planes, fragments within a view port are rendered by rasterization, without the clipping operation. Other invisible fragments out of the view port are erasable by the rasterization.

However, if conducting the clipping operation only with the near and far planes of a view volume, a parameter w representing a boundary of the view volume may become 0.

### SUMMARY

Example embodiments may provide a graphic processing system providing a more stable operation and an improved graphic processing speed.

Example embodiments may provide a graphic processing method providing a more stable operation and an improved graphic processing speed.

According to an example embodiment, a graphic processing method may include clipping a first polygon with a near plane of a view volume to create a second polygon, clipping the second polygon with a far plane of the view volume to create a third polygon, and/or discriminating if a homogeneous coordinate of the third polygon is 0. The third polygon may be clipped to one of left, right, top, and bottom planes of the view volume if the homogeneous coordinate of the third polygon is 0.

According to an example embodiment, the method may include transforming the homogeneous coordinate of the third polygon into a normal coordinate if the homogeneous coordinate of the third polygon is not 0.

According to an example embodiment, the method may include transforming a homogeneous coordinate of the first polygon into a normal coordinate if vertices of the first polygon are placed in an inner side of the near plane of the view volume.

According to an example embodiment, the method may include transforming a homogeneous coordinate of the second polygon into a normal coordinate if vertices of the second polygon are placed in an inner side the far plane of the view volume.

According to an example embodiment, the method may include discriminating if each homogeneous coordinate of vertices of the first polygon is negative or positive. The first polygon may be clipped with the near plane of the view volume unless the homogeneous coordinates of the vertices of the first polygon are at least one of all positive and all negative.

According to an example embodiment, a graphic processing apparatus may include a control circuit, a polygon view volume decider, and/or a vertex coordinate calculator. The control circuit may be configured to generate control signals. The polygon view volume decider may be configured to determine if vertices of a first polygon are placed in a view volume in response to the control signals. The vertex coordinate calculator may be configured to clip a polygon with a plurality of planes of the view volume in response to the control signals to generate vertex coordinate data for a new polygon. If the vertex coordinate calculator clips the first polygon with at least two planes of the view volume, the control circuit may be configured to control the new polygon to be clipped with another plane if a homogeneous coordinate of the new polygon is 0.

According to an example embodiment, the control circuit may be configured to control the first polygon to be clipped with the at least two planes of the view volume unless homogeneous coordinates of the vertices of the first polygon are at least one of all positive and all negative.

According to an example embodiment, the graphic processing apparatus may include a perspective division unit configured to transform the homogeneous coordinate of at least one of the first polygon and the new polygon into a normal coordinate.

According to an example embodiment, the control circuit may be configured to input the homogeneous coordinate of the first polygon to the perspective division unit if the vertices of the first polygon are placed in an inner side of the view volume.

According to an example embodiment, the polygon view volume decider may be configured to provide the control circuit with a positioning information signal representing locations of the vertices of the first polygon in at least one of the inner side of the view volume and an outer side of the view volume.

According to an example embodiment, the polygon view volume decider may include a comparison circuit and a register block. The comparison circuit may be configured to compare coordinate data of the vertices of the first polygon with coordinate data of the view volume and output the positioning information signal. The register block may be configured to store the positioning information signal.

According to an example embodiment, the polygon view volume decider may include a first multiplexer, a first discriminator, a second multiplexer, and/or a second discriminator. The first multiplexer may be configured to output a first coordinate value corresponding to one of the plurality of planes of the view volume in response to a first selection signal output from the control circuit. The first discriminator may be configured to compare the first coordinate value of the first multiplexer with a homogeneous coordinate of the first polygon and output a result of the comparison. The second multiplexer may be configured to output a second coordinate value corresponding to one of the plurality of planes of the view volume in response to a second selection signal output from the control circuit. The second discriminator may be configured to compare the second coordinate value of the second multiplexer with the homogeneous coordinate of the first polygon and output a result of the comparison.

According to an example embodiment, the register block may be configured to store signs of the homogeneous coordinates of the vertices of the first polygon.

### BRIEF DESCRIPTION OF THE DRAWINGS

The above and/or other aspects and advantages will become more apparent and more readily appreciated from the following detailed description of example embodiments taken in conjunction with the accompanying drawings of which:

FIG. 1 is a block diagram showing a graphic pipeline of a 3-dimensional graphic processing apparatus according to an example embodiment;

FIG. 2 is a block diagram illustrating a structure of the geometry engine shown in FIG. 1;

FIG. 3A is an example graphic diagram plotting a triangle to the homogeneous coordinate;

FIG. 3B is an example graphic diagram plotting a near clipping result to the polygon shown in FIG. 3A;

FIG. 3C is an example graphic diagram plotting a far clipping result to the polygon shown in FIG. 3B;

FIG. 4 is a block diagram illustrating a clipping unit according to an example embodiment;

FIG. 5 is a block diagram illustrating the view volume decider shown in FIG. 4;

FIG. 6 is a flow chart showing an example control sequence of clipping controlled by the FSM shown in FIG. 4;

FIG. 7A is an example graphic diagram plotting a polygon on the Z-W plane;

FIG. 7B is an example graphic diagram plotting a polygon after near and far clipping processes;

FIG. 7C is an example graphic diagram plotting a vertex g of w=0 of FIG. 7B on the Z-W plane;

FIG. 7D is an example graphic diagram plotting variation if clipping the vertex g on the axis of w=+x; and

FIG. 7E is an example graphic diagram showing the 3-dimensional feature of FIG. 7D on a 2-dimensional plane.

### DETAILED DESCRIPTION OF EXAMPLE EMBODIMENTS

Example embodiments will now be described more fully hereinafter with reference to the accompanying drawings. Embodiments may, however, be in many different forms and should not be construed as being limited to the example embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when a component is referred to as being “on,” “connected to” or “coupled to” another component, it can be directly on, connected to or coupled to the other component or intervening components may be present. In contrast, when a component is referred to as being “directly on,” “directly connected to” or “directly coupled to” another component, there are no intervening components present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the example embodiments.

Spatially relative terms, such as “beneath,” “below,” “lower,” “above,” “upper” and the like, may be used herein for ease of description to describe one component or feature's relationship to another component(s) or feature(s) as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Reference will now be made to example embodiments, which are illustrated in the accompanying drawings, wherein like reference numerals refer to the like components throughout.

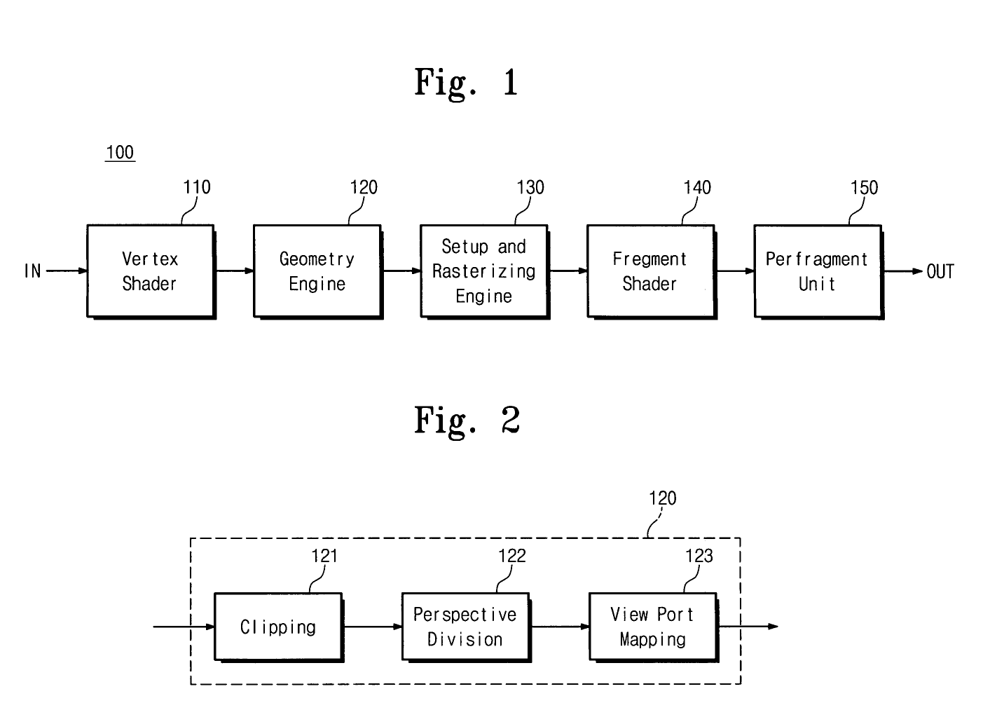

FIG. 1 is a block diagram showing a graphic pipeline of a 3-dimensional graphic processing apparatus according to an example embodiment.

The graphic pipeline 100 may include a vertex shader 110, a geometry engine 120, a setup and rasterizing engine 130, a fragment shader 140, and/or perfragment unit 150.

A graphic image signal IN, which may be provided from a host (not shown), may be input to the vertex shader 110. The vertex shader 110 may implement 3-dimensional graphic objects using various information, e.g., vertex coordinates, colors, and reflection values, and/or by processing relatively complicated operations with numerous data, e.g., matrixes, light sources, and textures, as well as coordinates varying along vertex positions. The vertex shader 110 may output coordinates (x, y, z, w).

The geometry engine 120 may process polygons and other graphic data to create images to be treated by the setup and rasterizing engine 130. The setup and rasterizing engine 130 may convert a vertex, which is input from the vertex shader 110, into a pattern for viewing on a display unit. The geometry engine 120 may create color contributions from a lighting source, generate fog factors to lower visibility as far as an object is apart from a viewer, and/or clip a scene into a given view volume.

The setup and rasterizing engine 130 may receive vertices transformed into screen coordinates, interpolate colors between vertices, and/or convert vertex representation in to a solid object by mapping an image.

A signal output from the setup and rasterizing engine 130 may be provided to a display unit through the fragment shader 140 and the perfragment unit 150 as an output signal OUT.

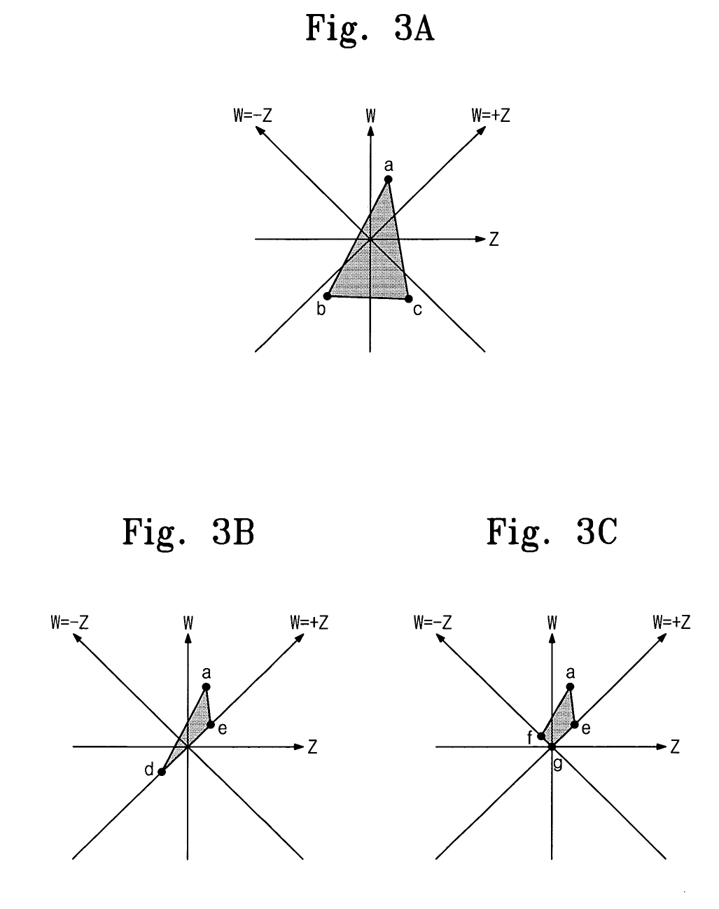

FIG. 2 is a block diagram illustrating a structure of the geometry engine 120 shown in FIG. 1.

Referring to FIG. 2, the geometry engine 120 may include a clipping unit 121, a perspective division unit 122, and/or a view-port mapping unit 123.

The clipping unit 121 may clip an object into a view volume. The perspective division unit 122 may calculate the fourth coordinate value w. The fourth coordinate value w may be used to correct a pixel coordinate (x, y, z). The view-port mapping unit 123 may transform a standard device coordinate into a screen or window coordinate. The standard device coordinate may be provided to show an image on a display unit.

The clipping unit 121 may define view volumes for applications models. Vertex data of a polygon in a view volume may be transferred to the next stage of the graphic pipeline, and/or vertex data out of the view volume may be abandoned to skip unnecessary operations. The process for discriminating visible portions and invisible portions with respect to a view volume may be called “3-dimensional graphic view volume clipping.”

The vertex shader 110 shown in FIG. 1 may conduct a matrix operation for model-viewer conversion and/or project vertices to a view volume defined by a user through a technique of perspective projection. A homogeneous coordinate may be used as a 4-dimensional coordinate system by the vertex shader 110. A coordinate (x, y, z) may define point having a 3-dimensional coordinate. 3-dimensional transformation (movement, rotation, etc.) may be performed using a 4×4 matrix, e.g., instead of direct calculation, for simpler and faster application. A component needs to be added to the coordinate (x, y, z) to use the 4×4 matrix. By adding the component w, the 4×4 matrix may form a coordinate (w, x, y, z) that that may be referred to as a homogeneous coordinate. The 3-dimensional coordinate (x, y, z) may be transformed into the corresponding homogeneous coordinate (w, x, y, z). For example, after applying perspective transformation for projecting a 3-dimensional object in two dimensions, the coordinate values may be output with change. In other words, the last coordinate component w may change to another value. Accordingly, the homogeneous coordinate may transform into an ordinary coordinate so the coordinate values may be practically used on a screen. For example, the coordinate components x, y, and z may be each divided by w. For example, (x/w, y/w, z/w, w/w)=(x/w, y/w, z/w, 1) and the fourth component value 1 may change to an ordinary coordinate value. Accordingly, the perspective division unit 122 may operate to change the homogeneous coordinate into the ordinary coordinate.

As such, in order to divide the coordinate components x, y, and z by w, the fourth component value w must be set to a value other than 0. However, in conducting the view volume clipping process in the clipping unit 121, the fourth component value w may become 0.

The homogeneous coordinate (x, y, z, w) of a vertex forming a model may be put into a perspective projection matrix by the clipping unit 121. After conducting the perspective projection matrix operation, if the values x′, y′, and z′ of the homogeneous coordinate (x′, y′, z′, w′) output from the clipping unit 121 are each smaller than or equal to the value w′, a vertex coordinate is placed in the view volume. If the values x′, y′, and z of the homogeneous coordinate (x′, y′, z′, w′) are each larger than the value w′, a vertex coordinate is placed out of the view volume. As a result, data values may be located in the view volume by comparing x′ to w′, y′ to w′, and z′ to w′.

The comparison may be summarized according to the following equation:

w≦x≦w,−w≦y≦w,−w≦z≦w(if w>0) (1)

w≦x≦−w,w≦y≦−w,w≦z≦−w(if w<0)

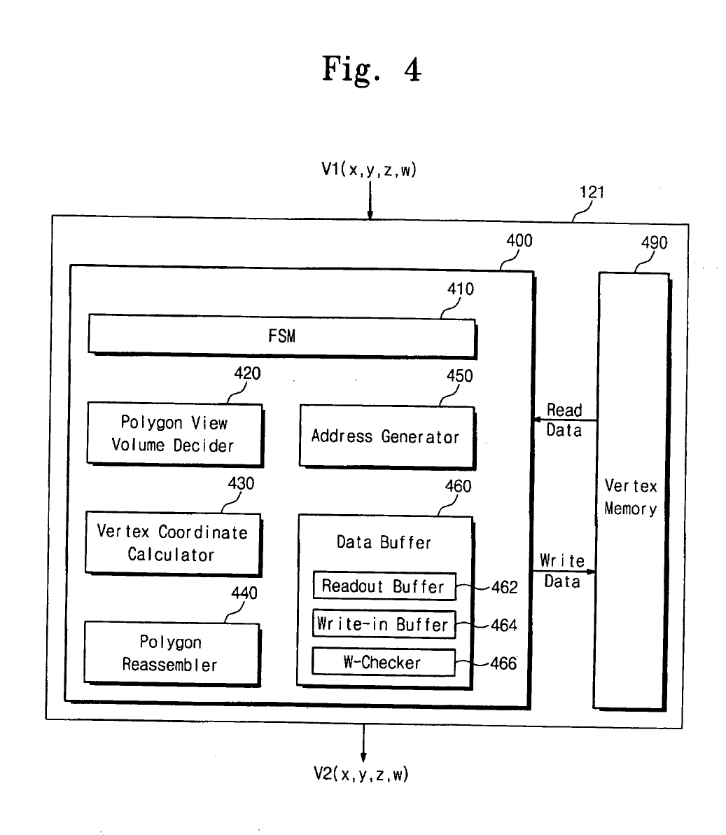

FIG. 3A is an example graphic diagram plotting a triangle as a polygon to the homogeneous coordinate (z, w), and FIG. 3B is an example graphic diagram plotting a near clipping result to the polygon shown in FIG. 3A. FIG. 3C is an example graphic diagram plotting a far clipping result to the polygon shown in FIG. 3B.

As illustrated in FIGS. 3A through 3C, if a polygon extends over a boundary of the view volume, vertex coordinate data for forming a new polygon may be obtained. Vertices of the polygon shown in FIG. 3A are placed at a, b, and c, and vertices a, b, and c may be changed to a, d, and e after the near clipping process. After the far clipping process, vertices of the polygon may be changed to a, e, f, and g. The coordinate value w of the polygon vertex g may be 0.

If w=0, an incorrect operation result may be generated if the operation of (x/w, y/w, z/w, w/w) is conducted for transforming the homogeneous coordinate into the ordinary coordinate by the perspective division unit 122. Example embodiments may be configured to avoid an incorrect operation result.

Example embodiments may provide a clipping scheme for correctly clipping a polygon, which has a negative value of w, in order to support various applications. Accordingly, a correct clipping result over the next pipeline stage may be enabled, and/or the number of operation cycles may be reduced to be less than a case in which all planes are clipped.

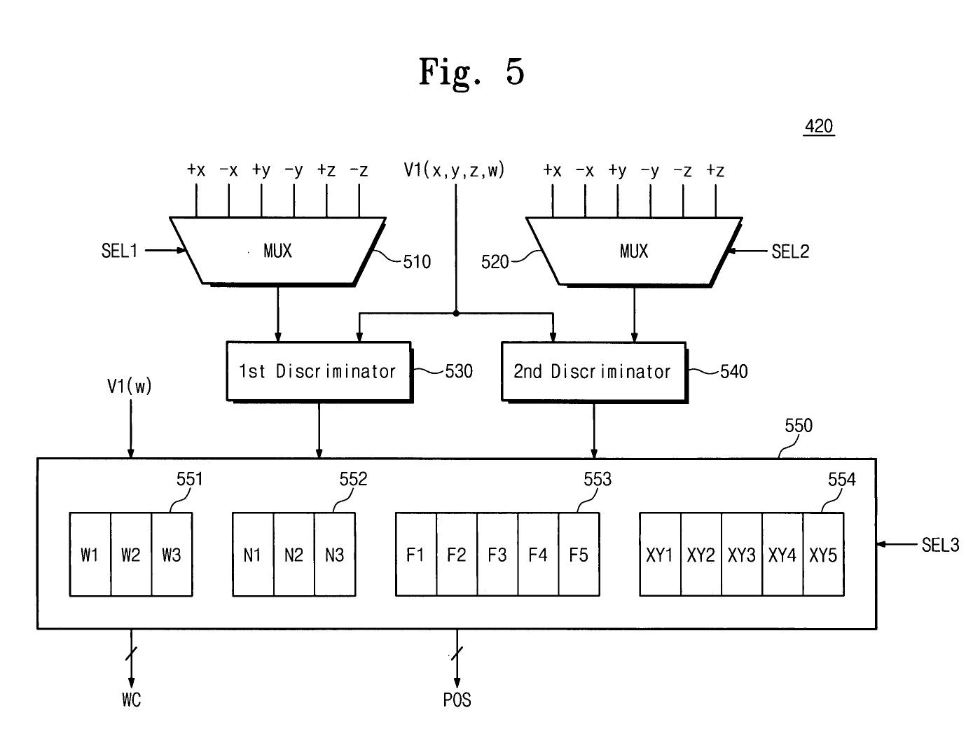

FIG. 4 is a block diagram illustrating the clipping unit 121 according to an example embodiment.

Referring to FIG. 4, the clipping unit 121 may include an operation unit 400 and/or a vertex memory 490. The operation unit 400 may conduct a clipping process for a polygon and/or store coordinate information about clipped vertices in the vertex memory 490. The operation unit 400 may include a finite state machine (FSM) 410, a polygon view volume decider 420, a vertex coordinate calculator 430, a polygon re-assembler 440, an address generator 450, and/or a data buffer 460. The coordinate V1(x, y, z, w) may be received by the clipping unit 121, and the clipping unit 121 may output the coordinate V2(x, y, z, w) to the next stage of the graphic pipeline.

The FSM 410 may control an overall function of the operation unit 400. The polygon view volume decider 420 may output positioning information informing that a vertex coordinate input from the vertex shaper 110 is placed in or out of the near and far clipping planes of the view volume.

The FSM 410 may receive the positioning information from the polygon view volume decider 420, and/or provide vertex coordinates to the polygon re-assembler 440 if all of the vertex coordinates are placed in the near and far clipping planes. If all of the vertex coordinates are placed out of the near and far clipping planes, the vertex coordinates may be removed. If the vertex coordinates extend over a near or far clipping plane, the polygon view volume decider 420 may be controlled to perform the clipping process for at least one of the left, right, top, and bottom planes, as well as the near and far planes of the polygon. However, the graphic processing may be faster than performing the clipping process for all of the left, right, top, bottom, near, and far planes.

The vertex coordinate calculator 430 may conduct the clipping process for the polygon and/or calculate coordinates values of vertices.

The polygon reassembler 440 may create information for linking each of the polygons newly generated by the clipping process to the left, right, top, and/or bottom planes.

The address generator 450 may generate control and address signals for accessing the vertex memory 490.

The data buffer 460 may include a readout buffer 462 holding correction data read from the vertex memory 490, a write-in buffer 464 holding vertex data to be stored in the vertex memory 490, and/or a w-checker 466 configured to check if the value of w is 0.

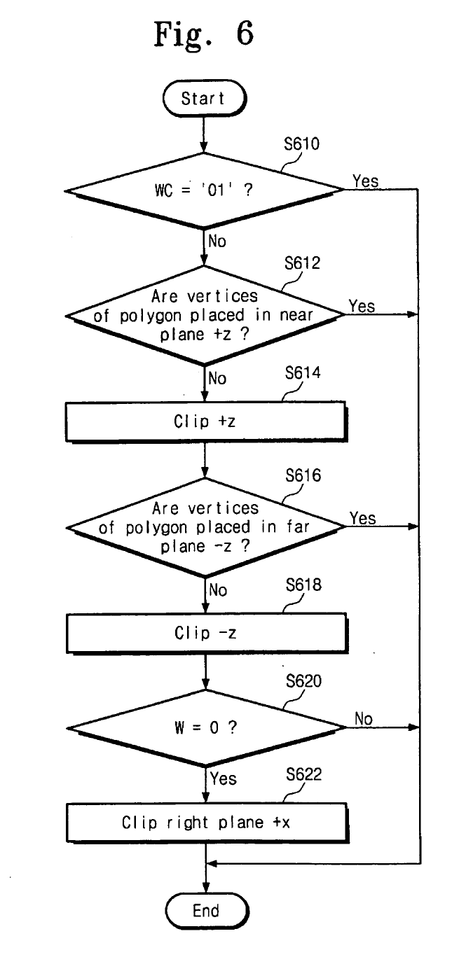

FIG. 5 is a block diagram illustrating the polygon view volume decider 420 shown in FIG. 4.

Referring to FIG. 5, the polygon view volume decider 420 may include multiplexers (MUX) 510 and 520, first and second discriminators 530 and 540, and/or a register block 550. The polygon view volume decider 420 may receive a coordinate V1(x, y, z, w) of a polygon, e.g., point, line, or triangle, from the FSM 410.

The multiplexers 510 and 520 may each receive a left-plane coordinate value −x, a right-plane coordinate value +x, a top-plane coordinate value +y, a bottom-plane coordinate value −y, a near-plane coordinate value −z, and/or a far-plane coordinate value +z of the view volume. The FSM 410 may input selection signals SEL1 and SEL2 each to the multiplexers 510 and 520. The FSM 410 may input selection signal SEL3 to the register block 550.

The first discriminator 530 may receive an output of the multiplexer 510 and a current polygon coordinate V1(x, y, z, w) and/or determine if the current polygon is placed in the view volume. The first discriminator 530 may output a digit ‘1’ if the polygon coordinate V1(x, y, z, w) is positioned in a more inner place than the coordinate value of the view volume. If the polygon coordinate V1(x, y, z, w) is positioned in a more outer place than the coordinate value of the view volume, the first discriminator 530 may output a digit ‘0’. The second discriminator 540 may receive an output of the multiplexer 520 and the current polygon coordinate V1(x, y, z, w), and the second discriminator 540 may operate in a manner similar to the first discriminator 530.

The register block 550 may include a register 551 for storing signs of the coordinate V1(w) of three vertices a, b, and c. The register 551 may store 3-bit information, which is composed of W1, W2, and W3, representing signs of the coordinate V1(w) corresponding each to the three vertices a, b, and c. According to an example embodiment, if the 3-bit information of W1˜W3 is all ‘1’, a first signal WC may become ‘10’. If the 3-bit information of W1˜W3 is all ‘0’, the first signal WC may become ‘01’. If the 3-bit information of W1˜W3 is not all ‘0’ or ‘1’, the first signal WC may become ‘00’.

If the first signal WC is set to ‘00’, the FSM 410 may determine that there is a need for at least one of the left, right, top, and bottom clipping processes, as well as the near and far clipping processes of the view volume, and/or control the polygon view volume decider 420 to determine whether the vertex coordinate V1(x, y, z, w) is positioned in or out of the view volume.

If the first signal WC is set to ‘10’, the FSM 410 may control the vertex coordinate calculator 430 to evaluate an intersection coordinate value of the vertices. If the first signal WC is set to ‘01’, the FSM 410 may determine the polygon as being out of the view volume and/or perform controls to erase the polygon.

Referring again to FIG. 5, the register block 550 may include registers 552, 553, and/or 554. The registers 552, 553, and 554 may store results output from the first and second discriminators 530 and 540. The discrimination results stored in the registers 552˜554 may be provided to the FSM 410 as a second signal POS. The FSM 410 may receive the second signal POS from the polygon view volume decider 420, and/or determines to clip the polygon planes and set a clipping type based on the second signal POS.

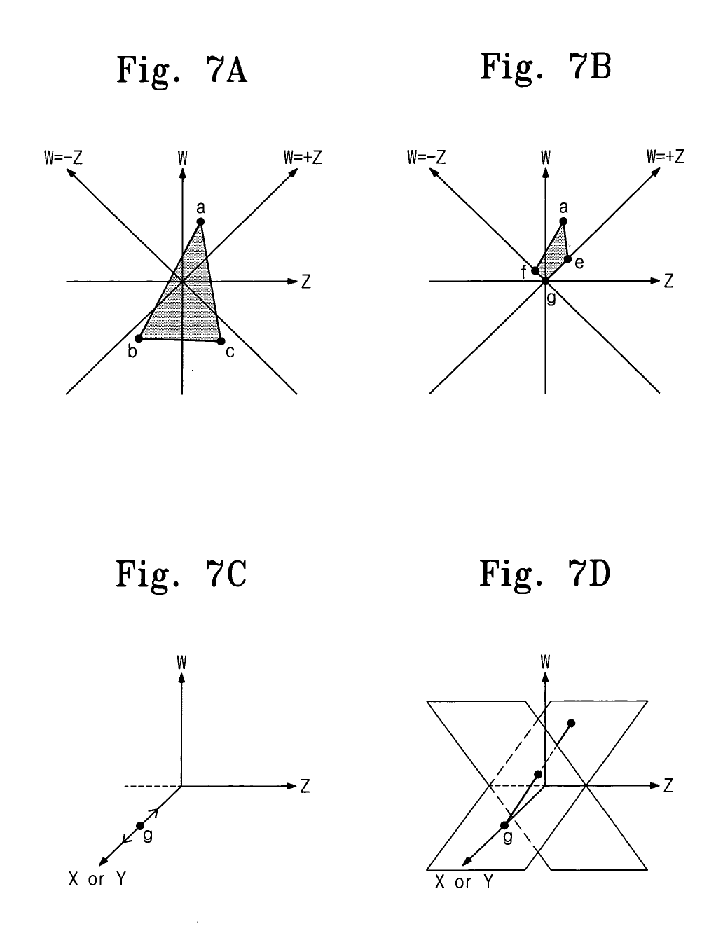

FIG. 6 is a flow chart showing an example control sequence of clipping controlled by the FSM 410 shown in FIG. 4.

Referring to FIG. 6, the FSM 410 may determine if the first signal WC input from the register block 550 is ‘01’ (S610). If the first signal WC is ‘01’ the FSM may determine the polygon as being out of the view volume and/or perform controls to erase the polygon. If the first signal WC is not ‘01’, the FSM 410 may control the view volume decider 420 to find positions of the polygon vertices. The FSM 410 may input a coordinate of one of the six planes in the view volume, the polygon coordinate V1(x, y, z, w), and the selection signals SEL1 and SEL2 to the polygon view volume decider 420.

The multiplexer 510 may output a near coordinate +z in response to the selection signal SEL1. The first discriminator 530 may find that one or more vertices are placed in the inner side of the near plane +z by comparing the coordinate V1(w) of each of the current polygon vertices with the near coordinate +z. For example, the first discriminator 530 may determine if the condition w≧+z (but, w>0) or w≦−z (but, w<0) is satisfied. The discrimination result may be stored in the register 552. Comparison results between the near coordinate +z and the coordinates V1(w) of the three vertices a, b, and c shown in FIG. 2A may be stored in the register 552 as referenced by N1, N2, and N3. For example, N1 may be set to ‘1’ if the coordinate V1(w) of the vertex a is placed in the near coordinate +z. N1 may be set to ‘0’ is the coordinate V1(w) of the vertex a is placed out of the near coordinate +z. Digit values of N2 and N3 may also be set in the register 552 in a manner similar to that described above in regards to the digit values of N1.

The multiplexer 520 may output the far coordinate −z in response to the selection signal SEL2. The second discriminator 540 may find that one or two vertices are placed in the inner side of the far plane −z by comparing the coordinate V1(w) of each of the current polygon vertices with the far coordinate −z. For example, the second discriminator 540 may determine if the condition w≧−z (but, w>0) or w≦−z (but, w<0) is satisfied. The discrimination result may be stored in the register 553. Comparison results between the far coordinate −z and the coordinates V1(w) of the three vertices a, b, and c shown in FIG. 2A may be stored in the register 553 as referenced by F1, F2, and F3. For example, F1 may be set to ‘1’ if the coordinate V1(w) of the vertex a is placed in the far coordinate −z. F1 may be set to ‘0’ if the coordinate V1(w) of the vertex a is placed out of the far coordinate −z. Digit values of F2 and F3 may also be set in the register 553 in a manner similar to that described above in regards to the digit values of F1.

The FSM 410 may receive positioning information of N1˜N3 and F1˜F3 from the registers 552 and 553 of the register block 550, and/or find the polygon vertices are placed in the inner side of the near plane +z (S612). If the polygon vertices are detected as being in the inner side of the near plane +z, the FSM 410 may terminate the clipping control operation to the current polygon. If the polygon vertices are detected as being in the outer side of the near plane +z, the FSM 410 may create a new polygon by conducting the near clipping process for the polygon and/or perform controls to calculate vertex coordinates of the new polygon (614). FIG. 2A shows an example new polygon created by the near clipping process on the axis of w=+z. The new polygon may include vertices a, d, and e.

The FSM 410 may control the view volume decider 420 to find if the new polygon vertices are placed in the inner side of the far plane −z (616). The multiplexer 510 of the polygon view volume decider 420 may output the far plane coordinate −z in response to the selection signal SEL1. The first discriminator 530 may compare the coordinate V1(w) of the new polygon vertices d and e with the far plane coordinate −z, and/or store the comparison results in the register 553 as referenced by F4 and F5.

The FSM 410 may receive the second signal POS, which includes the positioning information F4 and F5, from the polygon view volume decider 420, and/or determine if the polygon vertices are placed in the inner side of the far plane −z. If the polygon vertices are placed out of the far plane −z, the FSM 410 may control the vertex coordinate calculator 430 to conduct the far clipping process and to create a new polygon (S618). The vertex coordinate calculator 430 may output a coordinate of the new polygon vertices f and g, e.g., as shown in FIG. 2C, after the far clipping process.

The FSM 410 may discriminate that the coordinate V1(w) of the new polygon vertices f and g is 0 (S620). The discrimination, for checking if the coordinate V1(w) of the new polygon vertices f and g is 0, may be carried out by the w-checker 466 of the data buffer 460. The FSM may discriminate that the coordinate V1(w) of the new polygon vertices f and g is 0, in accordance with a resultant signal provided from the w-checker 466. If the coordinate V1(w) is 0, the FSM 410 may control the vertex coordinate calculator 430 to conduct the clipping process on the right plane by the axis of w=+x (S622).

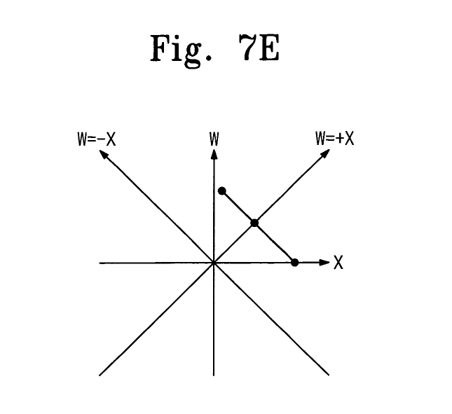

FIG. 7A is an example graphic diagram plotting a polygon including the vertices a, b, and c. FIG. 7B is a graphic diagram plotting a polygon including the vertices a, e, f, and g after the near and far clipping processes. FIG. 7C is an example graphic diagram plotting the vertex g of FIG. 7B on the Z-W plane. FIG. 7D is an example graphic diagram plotting a variation if clipping the vertex g on the axis of w=+x. FIG. 7E is an example graphic diagram showing the 3-dimensional feature of FIG. 7D on a 2-dimensional plane. As illustrated in FIGS. 7D and 7E, if the clipping process is conducted with a vertex, which is w =z=0, to the right plane +x, w changes to a value other than 0.

Coordinate data of the polygon vertices a, b, and c shown in FIG. 7A may be read from the vertex memory 490 by way of the data buffer 460 shown in FIG. 4. Coordinate data of the new polygon vertices, a, d, and e, and a, e, f, and g, may be stored in the vertex memory 490 by way of the data buffer 460.

As stated above, by performing the clipping process only for the near and far planes, instead of clipping all planes (i.e., near, far, left, right, top, and bottom), a same result as the clipping process to the left, right, top, and bottom planes may be provided. Accordingly, a technique of clipping only the near and far planes has been widely used in recent years. However, performing the clipping process only to the near and far planes may cause a result that w=0 in the homogeneous coordinate V1(x, y, z, w). Accordingly, an abnormal operation result while executing the operations of x/w, y/w, and z/w in the perspective division unit 122 that may be the next stage may occur. Therefore, if w=0 in clipping the near and far planes, a clipping process with one of the left, right, top, and bottom planes may be further carried out to change w into a value other than 0. As a result, a processing speed may be increased and a more stable operation may be assured in the 3-dimensional graphic processing apparatus.

If w=0 after clipping the near −z, far +z, and right +x, the FSM 410 may repeat the aforementioned sequence for changing w into a value other than 0 by conducting the clipping process to one of the left, right, top, and/or bottom planes.

According to example embodiments, a 3-dimensional graphic processing apparatus with improved graphic processing speed and a more stable operation may be provided.

Although example embodiments have been shown and described in this specification and figures, it would be appreciated by those skilled in the art that changes may be made to the illustrated and/or described example embodiments without departing from their principles and spirit.

What is claimed is:

1. A graphic processing method comprising:
clipping a first polygon with a near plane of a view volume to create a second polygon;
clipping the second polygon with a far plane of the view volume to create a third polygon;
discriminating if a homogeneous coordinate of the third polygon is 0; and
clipping the third polygon to one of left, right, top, and bottom planes of the view volume if the homogeneous coordinate of the third polygon is 0.

2. The graphic processing method as set forth in claim 1, further comprising:
transforming the homogeneous coordinate of the third polygon into a normal coordinate if the homogeneous coordinate of the third polygon is not 0.

3. The graphic processing method as set forth in claim 1, further comprising:
transforming a homogeneous coordinate of the first polygon into a normal coordinate if vertices of the first polygon are placed in an inner side of the near plane of the view volume.

4. The graphic processing method as set forth in claim 1, further comprising:
transforming a homogeneous coordinate of the second polygon into a normal coordinate if vertices of the second polygon are placed in an inner side the far plane of the view volume.

5. The graphic processing method as set forth in claim 1, further comprising:
discriminating if each homogeneous coordinate of vertices of the first polygon is negative or positive,
wherein the first polygon is clipped with the near plane of the view volume unless the homogeneous coordinates of the vertices of the first polygon are at least one of all positive and all negative.

6. A graphic processing apparatus comprising:
a control circuit configured to generate control signals;
a polygon view volume decider configured to determine if vertices of a first polygon are placed in a view volume in response to the control signals; and
a vertex coordinate calculator configured to clip a polygon with a plurality of planes of the view volume in response to the control signals to generate vertex coordinate data for a new polygon,
wherein, if the vertex coordinate calculator clips the first polygon with at least two planes of the view volume, the control circuit is configured to control the new polygon to be clipped with another plane if a homogeneous coordinate of the new polygon is 0.

7. The graphic processing apparatus as set forth in claim 6, wherein the control circuit is configured to control the first polygon to be clipped with the at least two planes of the view volume unless homogeneous coordinates of the vertices of the first polygon are at least one of all positive and all negative.

8. The graphic processing apparatus as set forth in claim 6, which further comprises:
a perspective division unit configured to transform the homogeneous coordinate of at least one of the first polygon and the new polygon into a normal coordinate.

9. The graphic processing apparatus as set forth in claim 8, wherein the control circuit is configured to input the homogeneous coordinate of the first polygon to the perspective division unit if the vertices of the first polygon are placed in an inner side of the view volume.

10. The graphic processing apparatus as set forth in claim 9, wherein the polygon view volume decider is configured to provide the control circuit with a positioning information signal representing locations of the vertices of the first polygon in at least one of the inner side of the view volume and an outer side of the view volume.

11. The graphic processing apparatus as set forth in claim 10, wherein the polygon view volume decider comprises:
a comparison circuit configured to compare coordinate data of the vertices of the first polygon with coordinate data of the view volume and output the positioning information signal; and
a register block configured to store the positioning information signal.

12. The graphic processing apparatus as set forth in claim 11, wherein the polygon view volume decider comprises:
a first multiplexer configured to output a first coordinate value corresponding to one of the plurality of planes of the view volume in response to a first selection signal output from the control circuit;
a first discriminator configured to compare the first coordinate value of the first multiplexer with a homogeneous coordinate of the first polygon and output a result of the comparison;
a second multiplexer configured to output a second coordinate value corresponding to one of the plurality of planes of the view volume in response to a second selection signal output from the control circuit; and
a second discriminator configured to compare the second coordinate value of the second multiplexer with the homogeneous coordinate of the first polygon and output a result of the comparison.

13. The graphic processing apparatus as set forth in claim 11, wherein the register block is configured to store signs of the homogeneous coordinates of the vertices of the first polygon.
